(19) United States
(12) Patent Application Publication
(10) Pub. No.: US 2024/0259941 A1
(43) Pub. Date: Aug. 1, 2024

(54) TRIGGERING A MAIN RECEIVER

(71) Applicant: Samsung Electronics Co., Ltd., Suwon-si (KR)

(72) Inventor: Hongbo Si, Allen, TX (US)

(21) Appl. No.: 18/412,939

(22) Filed: Jan. 15, 2024

Related U.S. Application Data
(60) Provisional application No. 63/442,329, filed on Jan. 31, 2023.
(60) Provisional application No. 63/612,487, filed on Dec. 20, 2023.

(51) Int. Cl. H04W 52/02; H04W 76/27

(52) U.S. Cl. CPC H04W 52/0229; H04W 52/0235; H04W 76/27

(57) ABSTRACT

Apparatuses and methods for triggering a main receiver (MR). A method of a user equipment (UE) in a wireless communication system is provided. The method includes receiving a low-power wake up signal (LP-WUS) using a low-power receiver (LR); determining, based on the LP-WUS, an indication on whether to trigger a transceiver of the UE to receive a physical downlink control channel (PDCCH); and receiving, using the transceiver, the PDCCH based on the indication.

### CROSS-REFERENCE TO RELATED AND CLAIM OF PRIORITY

The present application claims priority under 35 U.S.C. § 119(e) to: U.S. Provisional Patent Application No 63/442,329 filed on Jan. 31, 2023 and U.S. Provisional Patent Application No. 63/612,487 filed on Dec. 20, 2023, which is hereby incorporated by reference in its entirety.

### TECHNICAL FIELD

The present disclosure relates generally to wireless communication systems and, more specifically, the present disclosure is related to apparatuses and methods for triggering a main receiver (MR).

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to triggering a MR.

In one embodiment, a user equipment (UE) in a wireless communication system is provided. The UE includes a transceiver; a low-power receiver (LR) configured to receive a low-power wake up signal (LP-WUS); and a processor operably coupled to the transceiver and the LR. The processor is configured to determine, based on the LP-WUS, an indication on whether to trigger the transceiver to receive a physical downlink control channel (PDCCH). The transceiver is further configured to receive the PDCCH based on the indication.

In another embodiment, a method of a UE in a wireless communication system is provided. The method includes receiving a LP-WUS using a LR; determining, based on the LP-WUS, an indication on whether to trigger a transceiver of the UE to receive a PDCCH; and receiving, using the transceiver, the PDCCH based on the indication.

In yet another embodiment, a base station (BS) in a wireless communication system is provided. The BS includes a processor operably configured to determine an indication on whether a PDCCH is to be received by a UE and determine to include the indication in a LP-WUS. A transceiver operably coupled to the processor, the transceiver configured to transmit the LP-WUS and transmit the PDCCH when the indication in the LP-WUS indicates the PDCCH is to be received by the UE.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates a diagram for explicitly triggering the MR according to embodiments of the present disclosure;

FIG. 7 illustrates a diagram for an application delay according to embodiments of the present disclosure; and

FIG. 8 illustrates a flowchart of an example UE procedure for triggering the transition from using a LR to using a MR according to embodiments of the present disclosure.

### DETAILED DESCRIPTION

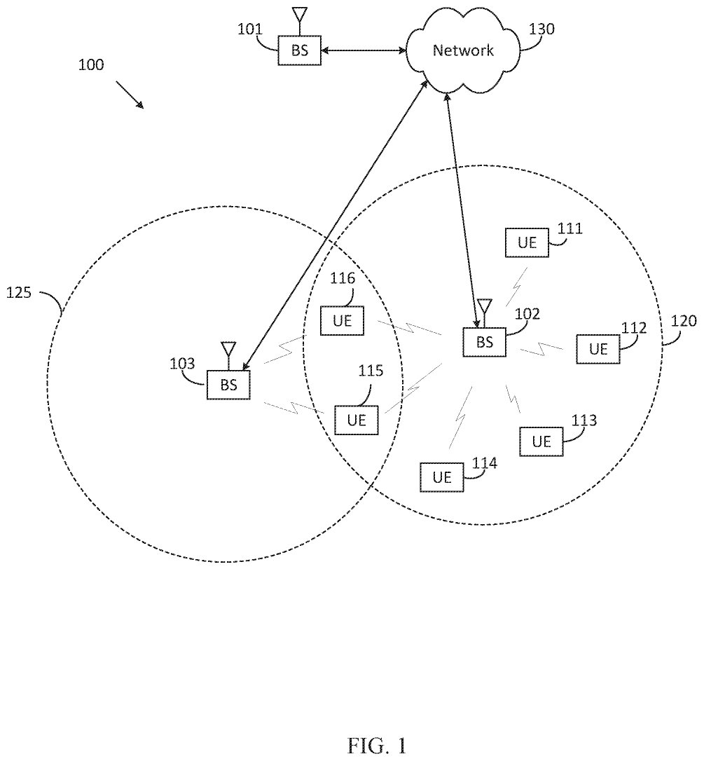

FIGS. 1-8, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band.

For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v17.1.0, “NR; Physical channels and modulation;” [2] 3GPP TS 38.212 v17.1.0, “NR; Multiplexing and channel coding;” [3] 3GPP TS 38.213 v17.1.0, “NR; Physical layer procedures for control;” [4] 3GPP TS 38.214 v17.1.0, “NR; Physical layer procedures for data;” and [5] 3GPP TS 38.331 v17.1.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for triggering a MR. In certain embodiments, one or more of the BSs 101-103 include circuitry, programing, or a combination thereof to support triggering a MR.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

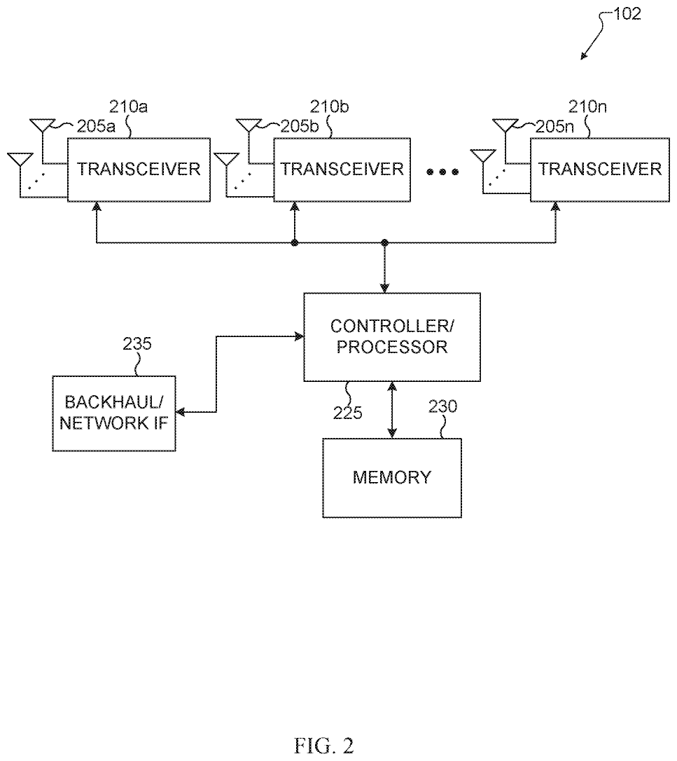

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for triggering a MR. Any of a wide variety of other functions could be supported in the gNB 102 by the controller/processor 225.

The controller/processor 225 is also capable of executing programs and other processes resident in the memory 230, such as processes to trigger a MR. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

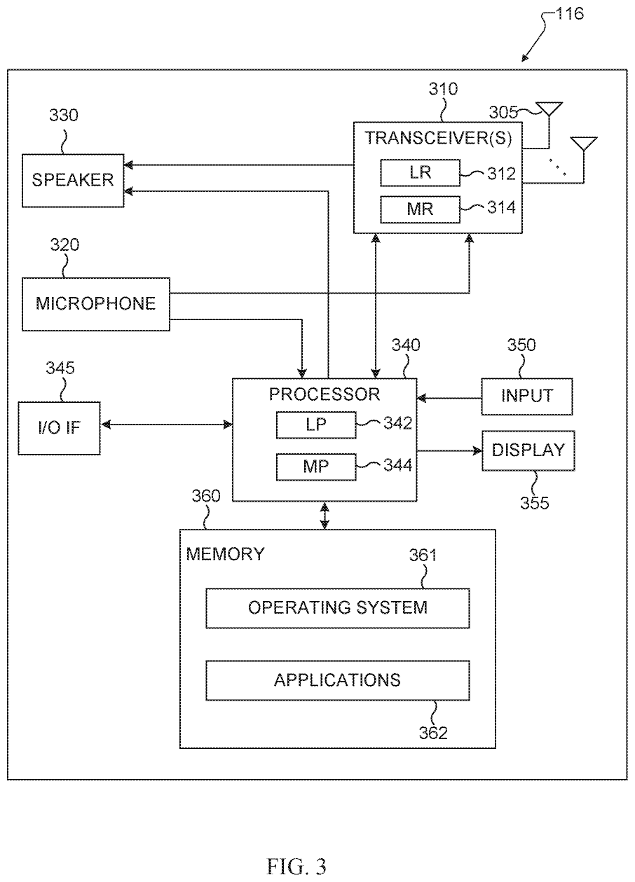

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for triggering a MR as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

In various embodiments, the transceiver(s) 310 include or are at least one LR 312 and at least one MR 314. For example, as discussed in greater detail below, the LR 312 may be configured or utilized to receive low power signals (e.g., a LP-WUS), for example, when the UE 116 is in a sleep state (e.g., such as an ultra-deep sleep state as discussed in greater detail below), while the MR 314 is powered off or in a low power state. For example, in some embodiments, the LR 312 may be a component of the transceiver(s) 310 used or powered on when the UE 116 is in the sleep state while the MR 314 is the transceiver(s) 310 and used when the UE 116 is not in the sleep state. In another example, in other embodiments, the LR 312 may be receiver that is separate or discrete from the transceivers(s) 310 which is the MR 314 used for ordinary reception operations when the UE 116 is not in the sleep state.

Analogously, in such embodiments, the processor 340 includes or is at least one of the low-power processor (LP) 342 and the main processor (MP) 344. For example, in some embodiments, the LR 312 and the MR 314 may be connected to and/or be controlled by the LP 342 and the MP 344, respectively, which are separate and/or discrete processors. In these embodiments, the LP 342 may operate at a lower power state than the MP 344 such that, when the UE is in the sleep state, the MP 344 may be powered off or in a low power state while the LP 342 can process any signals (e.g., such as a LP-WUS) received by the LR 312. In these embodiments, the operation of the LP 342 may consume less power than ordinary operations of the MP 344 would, thereby saving power of the UE 116 in the sleep state while maintaining the ability of the UE 116 to receive and process signals. In other embodiments, the LP 342 and the MP 344 may be components of the processor 340 where the LR 312 and the MR 314 may be connected to and/or be controlled by the LP 342 and the MP 344, respectively. In these embodiments, when the UE 116 is in the sleep state, MP 344 components of the processor 340 are powered off or in a low power state and LP 342 components operate to process signals (e.g., such as a LP-WUS) received by the LR 312. In these embodiments, the operation of the LP 342 components of the processor 340 may consume less power than ordinary operations of the processor 340 including the operations of the MP 344 components would, thereby saving power of the UE 116 in the sleep state while maintaining the ability of the UE 116 to receive and process signals.

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

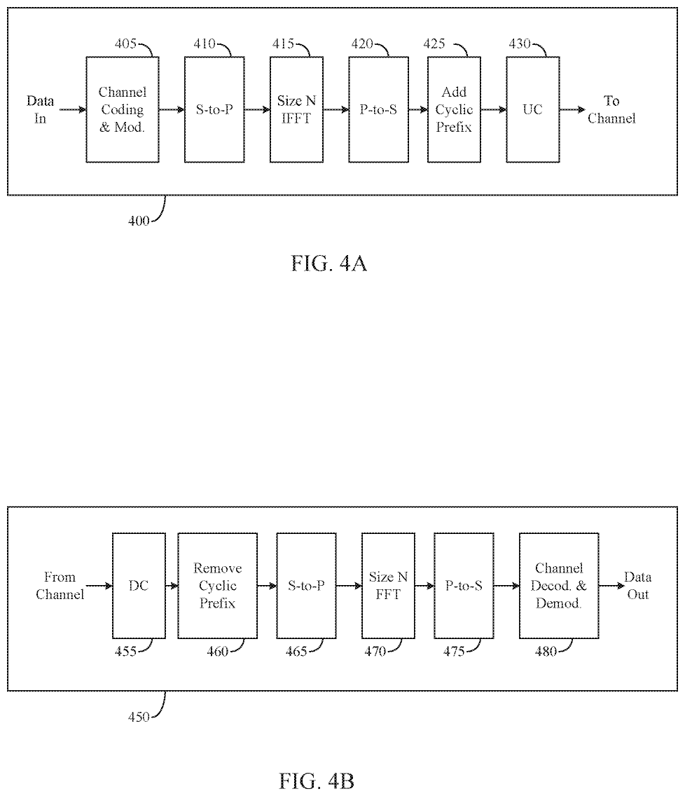

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the receive path 450 is configured for triggering a MR as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

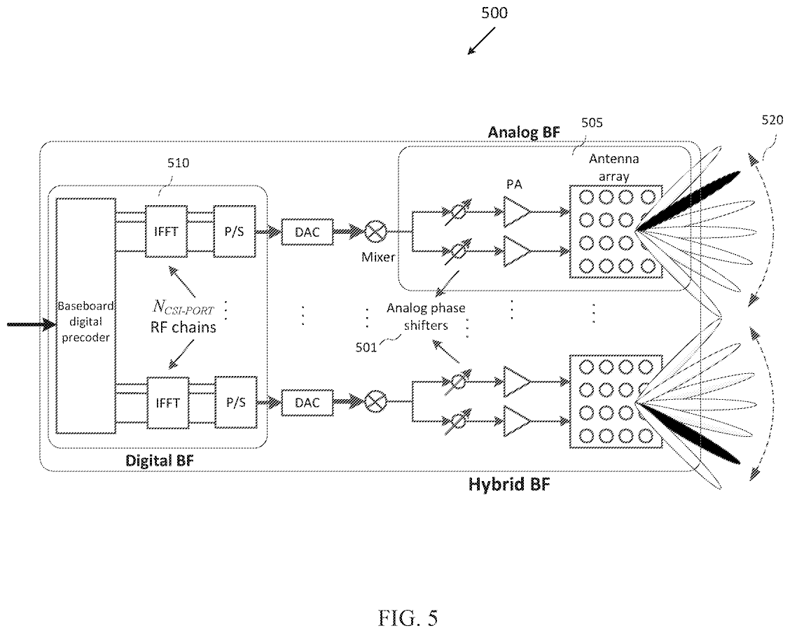

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4).

In this case, the system can employ only analog beams. Due to the O2 absorption loss around 60 GHz frequency (˜10 dB additional loss per 100 m distance), a larger number and narrower analog beams (hence a larger number of radiators in the array) are necessary to compensate for the additional path loss.

NR supported discontinuous reception (DRX) for a UE in either RRC_IDLE/RRC_INACTIVE mode or RRC_CONNECTED mode, such that the UE could stop receiving signals or channels during the inactive period within the DRX cycle and save power consumption. In Rel-16, enhancement towards DRX for RRC_CONNECTED mode (e.g., C-DRX) was introduced, wherein a new downlink control information (DCI) format was used to help the UE to skip an ON duration within a C-DRX cycle such that further power saving gain could be achieved. In Rel-17, enhancement towards DRX for RRC_IDLE/RRC_INACTIVE mode (e.g., I-DRX) was introduced, wherein a paging early indication (PEI) was used for a UE to skip monitoring paging occasions such that extra power saving gain could be achieved.

However, the UE still needs to frequently wake up to monitor the new DCI format or the PEI, such that the radio of the UE cannot be fully turned off for a long duration. Embodiments of the present disclosure recognize to avoid such situation and to acquire further power saving gain, an additional receiver radio is evaluated, wherein the additional receiver radio can be used for monitoring a particular set of signals with very low power consumption and the MR radio can be turned off or operating with a very lower power for a long duration.

This disclosure focuses on the mechanism of triggering the transition from using the additional receiver with low power to using the MR. This disclosure may focus on the UE in RRC_IDLE and/or RRC_INACTIVE and/or RRC_CONNECTED modes.

This disclosure focuses on the triggering mechanism for a receiver to receive the low power signal(s). More precisely, the following aspects are included in the disclosure:
Triggering mechanism
   Explicit trigger using a signal or channel
   Implicit trigger without using an explicit signal or channel
Application delay
   Application delay for the MR
   Application delay for the LR
   Radio resource management (RRM) measurement relaxation based on the application delays
   Extension of application delay(s)
Example UE procedure for triggering the MR

FIG. 6 illustrates a diagram 600 for explicitly triggering the MR according to embodiments of the present disclosure. For example, diagram 600 for explicitly triggering the MR can be done by the UE 116 of FIG. 3. This example is for illustration only and other embodiments can be used without departing from the scope of the present disclosure.

In one embodiment, an explicit signal or channel can trigger the transition from using a LR (e.g., such as LR 312) to using a MR (e.g., such as MR 314), or trigger the use/wake-up of the MR to receive signal/channel that can only be received by the MR (e.g., PDCCH), or trigger the LR to operate in a state with low power (e.g., not to receive the signal/channel with low power such as LP-WUS and/or LP-SS).

In one example, the explicit signal or channel can be received by the LR. For instance, the explicit signal or channel can be received by the UE with low power.

In one example, if the UE 116 is in RRC_IDLE mode, the UE 116 can transit to RRC_CONNECTED mode after receiving the explicit signal or channel.

In another example, if the UE 116 is in RRC_INACTIVE mode, the UE 116 can transit to RRC_CONNECTED mode after receiving the explicit signal or channel.

In one example, after receiving the explicit signal or channel, the UE can turn on the MR and try to receive MIB and/or SIBx (e.g., x=1 and/or x>1) and/or paging (e.g., PDCCH and/or PDSCH of paging) and/or PEI, based on the information included in the signal or channel (e.g., whether to receive the receive MIB and/or SIBx and/or paging and/or PEI). For instance, the UE can be in RRC_IDLE mode and/or RRC_INACTIVE mode.

In another example, after receiving the explicit signal or channel, the UE can turn on the MR and try to receive a PDCCH, based on the information included in the signal or channel (e.g., whether to receive the PDCCH). For instance, the UE can be in RRC_CONNECTED mode. For another instance, the PDCCH can be according to a specific search space (SS) set. For one sub-instance, the SS set can be a common SS set, e.g., CSS set for monitoring PDCCH with DCI format 2_6. For another sub-instance, the SS set can be a USS set for monitoring PDCCH. For yet another instance, the PDCCH can be according to any search space set that has been configured for the UE to monitor. For yet another instance, the PDCCH can be according to any search space set that has been configured for the UE to monitor and located in the ON duration (e.g., active duration) of C-DRX.

In one example, the explicit signal or channel can be sent by the gNB 102.

In one example, the explicit signal or channel can be cell-specific.

In another example, the explicit signal or channel can be UE-group-specific.

In yet another example, the explicit signal or channel can be UE-specific.

In one example, the explicit signal or channel can be low-power wake-up-signal (LP-WUS), wherein the LP-WUS may or may not be coupled with a synchronization signal received by the LR.

In one example, the explicit signal or channel could include information on whether the MR is triggered to wake up (e.g., for PDCCH monitoring). In another example, the UE assumes the successful reception of the explicit signal or channel indicates the MR is triggered to wake up (e.g., for PDCCH monitoring).

In yet another example, the explicit signal or channel could further include information on a time duration associated with the use of MR (e.g., for PDCCH monitoring). For one instance, the unit of the time duration can be a symbol, a slot, a ms, a frame, or a DRX cycle. For one sub-instance, the DRX cycle can be paging DRX cycle for RRC_IDLE or RRC_INACTIVE mode. For another sub-instance, the DRX cycle can be UE C-DRX cycle for RRC_CONNECTED mode. For another instance, the reference timing as the start of the time duration can be the symbol or slot where the signal or channel (e.g., explicit trigger) is received by the UE. For yet another instance, the reference timing as the start of the time duration can be a delay after the symbol or slot where the signal or channel (e.g., explicit trigger) is received by the UE, wherein the delay can be provided by a higher layer parameter, or fixed in the specification (e.g., as a default value if the higher layer parameter is not provided), or determined based on a UE capability. For yet another instance, the reference timing as the start of the time duration can be explicitly provided by the signal or channel (e.g., explicit trigger).

In another example, the explicit signal or channel could further include information on a time instance to start using the MR (e.g., for PDCCH monitoring). For one instance, the unit of the time duration can be a symbol, a slot, a ms, a frame, or a DRX cycle. For one sub-instance, the DRX cycle can be paging DRX cycle for RRC_IDLE or RRC_INACTIVE mode. For another sub-instance, the DRX cycle can be UE C-DRX cycle for RRC_CONNECTED mode. In yet another example, the explicit signal or channel could further include information on one or more RRC state the UE can operate with using the MR (e.g., for PDCCH monitoring). For one instance, the RRC state can be RRC_IDLE state. For another instance, the RRC state can be RRC_INACTIVE state. For yet another instance, the RRC state can be RRC_CONNECTED state.

In yet another example, the explicit signal or channel could further include information on the reason for triggering the MR or UE procedure after triggering the MR. For one instance, the information can be the reception of system information (e.g., SIB1 or SIBx). For another instance, the information can be the reception of a SS/PBCH block. For yet another instance, the information can be the reception of paging (e.g., PDCCH and/or PDSCH of paging). For yet another instance, the information can be the reception of paging short message. For yet another instance, the information can be the reception of a paging early indication (PEI). For yet another instance, the information can be the update of system information. For yet another instance, the information can be performing RRM measurement. For yet another instance, the information can be the reception of user data. For yet another instance, the information can be measurement report.

In yet another example, the explicit signal or channel could further include information on the type of search space set and/or PDCCH to be monitored after the MR is triggered (e.g., for PDCCH monitoring). For one instance, the search space set can be a CSS set. For another instance, the search space set can be a USS set. For one instance, the PDCCH can be Type0-PDCCH. For another instance, the PDCCH can be Type0A-PDCCH. For yet another instance, the PDCCH can be Type1-PDCCH. For yet another instance, the PDCCH can be Type1A-PDCCH. For yet another instance, the PDCCH can be Type2-PDCCH. For yet another instance, the PDCCH can be Type2A-PDCCH. For yet another instance, the PDCCH can be Type3-PDCCH.

In yet another example, the explicit signal or channel could further include indication on whether the cell is bared/allowed to be accessed. In yet another example, the explicit signal or channel could further include information on the identification (ID) to guide the corresponding UE(s) to wake up the MR (e.g., for PDCCH monitoring). For one further consideration, a UE receiving the explicit signal or channel can compare the identification with its own information on the identification: if the identification matches, the UE decides to wake up the MR (e.g., for PDCCH monitoring). For one instance, the ID can be a cell ID. For another instance, the ID can be a UE group ID. For yet another instance, the ID can be a UE ID. For one sub-instance, the UE ID can be an ID within a UE group.

In yet another example, the explicit signal or channel could further include timing information. For one instance, the timing information can be SS/PBCH block index. For yet another instance, the timing information can be OFDM symbol index within a slot. For yet another instance, the timing information can be slot index, e.g., within a frame. For yet another instance, the timing information can be half frame index. For yet another instance, the timing information can be frame index. For yet another instance, the timing information can be SFN or k LSBs of SFN.

In yet another example, the explicit signal or channel could further include configuration of DRX or update of the configuration of DRX. For one instance, the explicit signal or channel can include an index for a set of DRX configurations, wherein, e.g., one or multiple sets of DRX configurations can be provided to the UE before using the LR. For another instance, the explicit signal or channel can include at least one parameter in the set of DRX configurations, e.g., a period, an offset, or a duration, and the UE applies the at least one parameter for the DRX after waking up the MR (e.g., for PDCCH monitoring). For one instance, the DRX can be paging DRX and/or extended paging DRX in RRC_IDLE and/or RRC_INACTIVE mode. For another instance, the DRX can be C-DRX in RRC_CONNECTED mode.

In yet another example, the explicit signal or channel could further include information on the system information update. In one example, if the UE does not receive the explicit signal or channel in one of the reception occasion or receives the explicit signal or channel that indicates the UE not to wake up the MR (e.g., for PDCCH monitoring), the UE may keep using the LR (e.g., keep monitoring low power signal that can be received by the LR such as LP-WUS).

In another example, if the UE receives the explicit signal or channel in one of the reception occasion, the UE may keep using the LR and ignore the explicit signal or channel (e.g., keep monitoring low power signal that can be received by the LR such as LP-WUS). For one sub-instance, this is applicable for RRC_IDLE and/or RRC_INACTIVE mode. For another sub-instance, this is applicable for RRC_CONNECTED mode. For one sub-instance, this is applicable subject to a UE capability. For another sub-instance, this is applicable subject to an indication in the UE assistance information. For yet another sub-instance, this is applicable subject to a network indication (e.g., configured by a higher layer parameter).

In yet another example, if the UE does not receive the explicit signal or channel in K reception occasions and/or receives the explicit signal or channel K times that indicates the UE not to wake up the MR (e.g., for PDCCH monitoring) and/or the combination of the two scenarios for K times (e.g., K is a positive integer), the UE may wake up the MR (e.g., for PDCCH monitoring). For one instance, K reception occasions can be consecutive reception occasions. For another instance, K can be an integer fixed in the specification (e.g., potentially determined based on a subcarrier spacing). For yet another instance, K can be provided by a higher layer parameter. For yet another instance, K can be provided by a higher layer parameter, and if not provided, K can be an integer fixed in the specification (e.g., potentially determined based on a subcarrier spacing). For one sub-instance, this is applicable for RRC_IDLE and/or RRC_INACTIVE mode. For another sub-instance, this is applicable for RRC_CONNECTED mode. For one sub-instance, this is applicable subject to a UE capability. For another sub-instance, this is applicable subject to an indication in the UE assistance information. For yet another sub-instance, this is applicable subject to a network indication (e.g., configured by a higher layer parameter).

In yet another example, the gNB may transmit the explicit signal or channel in one or multiple occasions to trigger using the MR (e.g., for PDCCH monitoring). For instance, the gNB may assume the explicit signal or channel is successfully received by the UE when the gNB receives an UL transmission from the UE. For one sub-instance, the UL transmission can be a Msg1 (e.g., PRACH) transmission in a 4-step RACH. For another sub-instance, the UL transmission can be a Msg3 transmission in a 4-step RACH. For yet another sub-instance, the UL transmission can be a MsgA transmission in a 2-step RACH. For yet another sub-instance, the UL transmission can be a PUCCH. For yet another sub-instance, the UL transmission can be a PUSCH. For yet another sub-instance, the UL transmission can be a UL RS (e.g., SRS). For yet another sub-instance, the UL transmission can be any UL signal or channel. For yet another sub-instance, the UE transmission can be a dedicated UL transmission for confirming the reception of the explicit signal or channel. For one sub-instance, this is applicable for RRC_IDLE and/or RRC_INACTIVE mode. For another sub-instance, this is applicable for RRC_CONNECTED mode. For one sub-instance, this is applicable subject to a UE capability. For another sub-instance, this is applicable subject to an indication in the UE assistance information. For yet another sub-instance, this is applicable subject to a network indication (e.g., configured by a higher layer parameter).

In yet another example, the UE may autonomously wake up the MR (e.g., for PDCCH monitoring), e.g., regardless of the reception of the explicit signal or channel. For one sub-instance, this is applicable for RRC_IDLE and/or RRC_INACTIVE mode. For another sub-instance, this is applicable for RRC_CONNECTED mode. For one sub-instance, this is applicable subject to a UE capability. For another sub-instance, this is applicable subject to an indication in the UE assistance information. For yet another sub-instance, this is applicable subject to a network indication (e.g., configured by a higher layer parameter).

For one example of the information included in the explicit signal or channel, the information can be carried or partially carried by the message before encoding of the explicit signal or channel, assuming the explicit signal or channel is message-based. For another example of the information included in the explicit signal or channel, the information can be carried or partially carried by the RNTI of the message, assuming the explicit signal or channel is message-based.

For yet another example of the information included in the explicit signal or channel, the information can be carried or partially carried by the scrambling sequence of the message, assuming the explicit signal or channel is message-based. For one example of the information included in the explicit signal or channel, the information can be carried or partially carried by the initial condition of the sequence mapped for the explicit signal or channel, assuming the explicit signal or channel is sequence-based.

For another example of the information included in the explicit signal or channel, the information can be carried or partially carried by the cyclic shift or combination of cyclic shifts of the sequence mapped for the explicit signal or channel, assuming the explicit signal or channel is sequence-based. For another example of the information included in the explicit signal or channel, the information can be carried or partially carried by the phase rotation value of the sequence mapped for the explicit signal or channel, assuming the explicit signal or channel is sequence-based.

For one example of the information included in the explicit signal or channel, the information can be carried or partially carried by the DMRS sequence of the explicit signal or channel. For another example of the information included in the explicit signal or channel, the information can be carried or partially carried by the time and/or frequency domain occasions of the explicit signal or channel within a number of candidate occasions (e.g., represented by a relative occasion index within the number of candidate occasions).

For one example of the information included in the explicit signal or channel, the information can be carried or partially carried by the overlaid sequence of the explicit signal or channel.

In one embodiment, the transition from using a LR to using a MR, or initiating the use/wake-up of the MR to receive signal/channel that can only be received by the MR (e.g., PDCCH), or enabling the LR to operate in a state with low power (e.g., not to receive the signal/channel with low power such as LP-WUS and/or LP-SS), can be triggered implicitly, e.g., triggered by an implicit trigger.

In one example, if the UE is in RRC_IDLE mode, the UE can transit to RRC_CONNECTED mode after applying the implicit trigger.

In another example, if the UE is in RRC_INACTIVE mode, the UE can transit to RRC_CONNECTED mode after applying the implicit trigger.

In one example, after applying the implicit trigger, the UE can turn on the MR and try to receive MIB and/or SIBx (e.g., x=1 and/or x>1) and/or paging (e.g., PDCCH and/or PDSCH of paging) and/or PEI, based on the information included in the signal or channel (e.g., whether to receive the receive MIB and/or SIBx and/or paging and/or PEI). For instance, the UE can be in RRC_IDLE mod and/or RRC_INACTIVE mode.

In another example, after applying the implicit trigger, the UE can turn on the MR and try to receive a PDCCH, based on the information included in the signal or channel (e.g., whether to receive the PDCCH). For instance, the UE can be in RRC_CONNECTED mode. For another instance, the PDCCH can be according to a specific search space (SS) set. For one sub-instance, the SS set can be a common SS set, e.g., CSS set for monitoring PDCCH with DCI format 2_6. For another sub-instance, the SS set can be a USS set for monitoring PDCCH. For yet another instance, the PDCCH can be according to any search space set that has been configured for the UE to monitor. For yet another instance, the PDCCH can be according to any search space set that has been configured for the UE to monitor and located in the ON duration (e.g., active duration) of C-DRX.

In one example, the implicit trigger can be based on a timing. The transition from using a LR to using a MR, or initiating the use/wake-up of the MR to receive signal/channel that can only be received by the MR (e.g., PDCCH), or enabling the LR to operate in a state with low power, can be triggered when the particular timing instance arrives.
For one sub-example, the timing can be an OFDM symbol boundary.
For another sub-example, the timing can be a slot boundary.
For yet another sub-example, the timing can be a frame boundary.
For yet another sub-example, the timing can be a DRX cycle boundary or a ON duration starting boundary within a DRX cycle. For one sub-instance, the DRX cycle can be paging DRX cycle for RRC_IDLE or RRC_INACTIVE mode. For another sub-instance, the DRX cycle can be UE C-DRX cycle for RRC_CONNECTED mode.

In another example, the implicit trigger can be based on a timer. The transition from using a LR to using a MR, or initiating the use/wake-up of the MR to receive signal/channel that can only be received by the MR (e.g., PDCCH), or enabling the LR to operate in a state with low power can be triggered when the timer expires.

In another example, the implicit trigger can be based on DRX cycle configuration in RRC_IDLE and/or RRC_INACTIVE mode.
For one sub-example, the implicit trigger can be aligned with a paging occasion.
For another sub-example, the implicit trigger can be aligned with a monitoring occasion for PEI.

In yet another example, the implicit trigger can be based on DRX cycle configuration in RRC_CONNECTED mode.
For one sub-example, the implicit trigger can be aligned with the ON duration in a DRX cycle.
For another sub-example, the implicit trigger can be aligned with a boundary of a period for the DRX cycle.

In yet another example, the implicit trigger can be based on reception situation of the LR.
For one sub-example, if the UE (e.g., using LR) misses the reception of a DL signal or channel consecutively for K times, the UE can assume to transit from using a LR to using a MR, or initiating the use/wake-up of the MR to receive signal/channel that can only be received by the MR (e.g., PDCCH), or enabling the LR to operate in a state with low power. In this sub-example, the DL signal or channel can be at least one of a LP-SS, LP-WUS, or a portion of LP-WUS. In this sub-example, K can be either fixed in the specification (e.g., potentially determined based on a subcarrier spacing), or provided by a higher layer parameter, or provided by a higher layer parameter, and if not provided, K can be an integer fixed in the specification (e.g., potentially determined based on a subcarrier spacing).
For another sub-example, the UE (e.g., using LR) does not receive a DL signal or channel for a time duration, the UE can assume to transit from using a LR to using a MR, or initiating the use/wake-up of the MR to receive signal/channel that can only be received by the MR (e.g., PDCCH), or enabling the LR to operate in a state with low power. In this sub-example, the DL signal or channel can be at least one of a LP-SS, LP-WUS, or a portion of LP-WUS. In this sub-example, the time duration can be either fixed in the specification (e.g., potentially determined based on a subcarrier spacing), or provided by higher layer parameter, or provided by a higher layer parameter, and if not provided, the time duration can be an integer fixed in the specification (e.g., potentially determined based on a subcarrier spacing).

In yet another example, the implicit trigger can be based on the RRM measurement performed by the UE (e.g., using LR).
For one sub-example, if the UE (e.g., using LR) measures a RS with a bad RRM measurement result (e.g., the measurement metric is lower than a threshold) for a consecutive number of times (e.g., K times), the UE can assume to transit from using a LR to using a MR, or initiating the use/wake-up of the MR to receive signal/channel that can only be received by the MR (e.g., PDCCH), or enabling the LR to operate in a state with low power. For one instance in this sub-example, K can be either fixed in the specification (e.g., potentially determined based on a subcarrier spacing), or provided by a higher layer parameter, or provided by a higher layer parameter, and if not provided, K can be an integer fixed in the specification (e.g., potentially determined based on a subcarrier spacing). For another instance in this sub-example, the threshold for the ratio can be either fixed in the specification (e.g., potentially determined based on a subcarrier spacing), or provided by a higher layer parameter, or provided by a higher layer parameter, and if not provided, the threshold can be a value fixed in the specification (e.g., potentially determined based on a subcarrier spacing).
For another sub-example, if the UE (e.g., using LR) measures a RS with a ratio of bad RRM measurement result (e.g., the measurement metric is lower than a first threshold) exceeding a second threshold based on K measurement instances, the UE can assume to transit from using a LR to using a MR, or initiating the use/wake-up of the MR to receive signal/channel that can only be received by the MR (e.g., PDCCH), or enabling the LR to operate in a state with low power. For one instance in this sub-example, K can be either fixed in the specification (e.g., potentially determined based on a subcarrier spacing), or provided by a higher layer parameter, or provided by a higher layer parameter, and if not provided, K can be an integer fixed in the specification (e.g., potentially determined based on a subcarrier spacing). For another instance in this sub-example, the first threshold can be either fixed in the specification (e.g., potentially determined based on a subcarrier spacing), or provided by a higher layer parameter, or provided by a higher layer parameter, and if not provided, the first threshold can be a value fixed in the specification (e.g., potentially determined based on a subcarrier spacing). For yet another instance in this sub-example, the second threshold can be either fixed in the specification (e.g., potentially determined based on a subcarrier spacing), or provided by a higher layer parameter, or provided by a higher layer parameter, and if not provided, the second threshold can be a value fixed in the specification (e.g., potentially determined based on a subcarrier spacing).
For yet another sub-example, if the UE (e.g., using LR) measures a RS with a bad RRM measurement result (e.g., the measurement metric is lower than a threshold) for a consecutive number of times within a duration, the UE can assume to transit from using a LR to using a MR, or initiating the use/wake-up of the MR to receive signal/channel that can only be received by the MR (e.g., PDCCH), or enabling the LR to operate in a state with low power. For one instance in this sub-example, the duration can be either fixed in the specification (e.g., potentially determined based on a subcarrier spacing), or provided by a higher layer parameter, or provided by a higher layer parameter, and if not provided, the duration can be a value fixed in the specification (e.g., potentially determined based on a subcarrier spacing).
For yet another sub-example, if the UE (e.g., using LR) measures a RS with a ratio of bad RRM measurement result (e.g., the measurement metric is lower than a first threshold) exceeding a second threshold within a duration, the UE can assume to transit from using a LR to using a MR, or initiating the use of the MR, or enabling the LR to operate in a state with low power. For one instance in this sub-example, the duration can be either fixed in the specification (e.g., potentially determined based on a subcarrier spacing), or provided by higher layer parameter, or provided by higher layer parameter and if not provided, the duration can be a value fixed in the specification (e.g., potentially determined based on a subcarrier spacing). For another instance in this sub-example, the first threshold can be either fixed in the specification (e.g., potentially determined based on a subcarrier spacing), or provided by a higher layer parameter, or provided by a higher layer parameter, and if not provided, the first threshold can be a value fixed in the specification (e.g., potentially determined based on a subcarrier spacing). For yet another instance in this sub-example, the second threshold can be either fixed in the specification (e.g., potentially determined based on a subcarrier spacing), or provided by a higher layer parameter, or provided by a higher layer parameter, and if not provided, the second threshold can be a value fixed in the specification (e.g., potentially determined based on a subcarrier spacing).
In one further consideration of the sub-examples, the RS for RRM measurement can be at least one of a LP-SS, or LP-WUS, or a portion of the LP-WUS.
In another further consideration of the sub-examples, the RRM measurement metric can be at least one of a RSRP, or RSRQ, or SINR, or reference signal antenna relative phase (RSARP).

For one example, the gNB may assume the MR is enabled (e.g., by the implicit trigger) (e.g., for PDCCH monitoring), when the gNB receives an UL transmission from the UE.
For one sub-instance, the UL transmission can be a Msg1 (e.g., PRACH) transmission in a 4-step RACH. For another sub-instance, the UL transmission can be a Msg3 transmission in a 4-step RACH. For yet another sub-instance, the UL transmission can be a MsgA transmission in a 2-step RACH. For yet another sub-instance, the UL transmission can be a PUCCH. For yet another sub-instance, the UL transmission can be a PUSCH. For yet another sub-instance, the UL transmission can be a UL RS (e.g., SRS).
For yet another sub-instance, the UL transmission can be any UL signal or channel.
For one sub-instance, this is applicable for RRC_IDLE and/or RRC_INACTIVE mode.
For another sub-instance, this is applicable for RRC_CONNECTED mode.
For one sub-instance, this is applicable subject to a UE capability.
For another sub-instance, this is applicable subject to an indication in the UE assisstent information.
For yet another sub-instance, this is applicable subject to a network indication (e.g., configured by a higher layer parameter).

In another example, the UE may autonomously wake up the MR (e.g., for PDCCH monitoring), e.g., regardless of the implicit trigger.
For one sub-instance, this is applicable for RRC_IDLE and/or RRC_INACTIVE mode.
For another sub-instance, this is applicable for RRC_CONNECTED mode.
For one sub-instance, this is applicable subject to a UE capability.
For another sub-instance, this is applicable subject to an indication in the UE assistance information.
For yet another sub-instance, this is applicable subject to a network indication (e.g., configured by a higher layer parameter).

For one example, a UE can support both the explicit trigger (e.g., explicit trigger) and implicit trigger.
For one sub-example, if the UE is not provided with the explicit trigger or a configuration of the explicit trigger, the UE uses the implicit by default.
For another sub-example, if the UE does not receive explicit trigger for one or multiple times, the UE uses the implicit by default. For one instance, the number of the multiple times can be fixed in the specification (e.g., potentially determined based on a subcarrier spacing). For another instance, the number of the multiple times can be provided by a higher layer parameter. For yet another instance, the number of the multiple times can be provided by a higher layer parameter, and if not provided, the number of the multiple times can use a fixed value in the specification by default (e.g., potentially determined based on a subcarrier spacing).

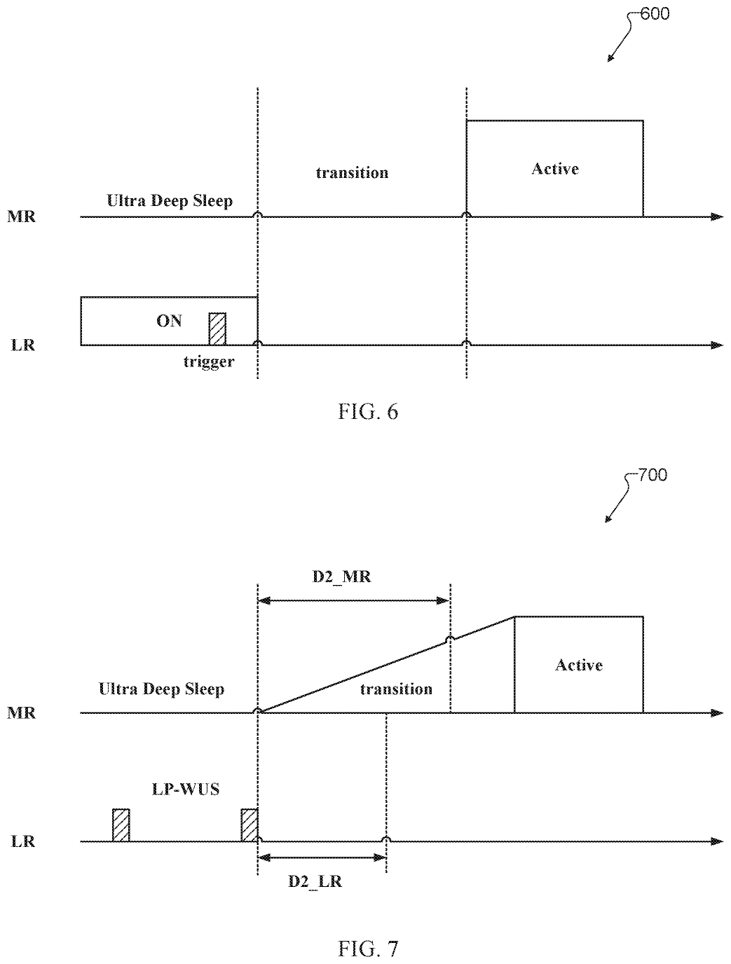

FIG. 7 illustrates a diagram 700 for an application delay according to embodiments of the present disclosure. For example, diagram 700 for an application delay can be utilized by any of the UEs 111-116 of FIG. 1. This example is for illustration only and can be used without departing from the scope of the present disclosure.

In one embodiment, there can be an application delay for the MR (e.g., such as MR 314) to transit from using a LR (e.g., such as LR 312 to using the MR, or to trigger the use/wake-up of the MR to receive signal/channel that can only be received by the MR (e.g., PDCCH). With reference to FIG. 7, the application delay for the MR is denoted as D2_MR.

In one example, the application delay for MR can be 0.

In one example, the application delay is determined using a reference timing as the reception of the explicit trigger (e.g., the starting or ending instance of the explicit signal or channel).

In another example, the application delay is determined using a reference timing as the implicit trigger.

In one example, the application delay can be used for the UE to prepare for waking up the MR and ready for transmission and/or reception (e.g., of a PDCCH), e.g., preparation time.

In one example, a maximum value of the application delay or a minimum value of the application delay or the value of the application delay can be determined by the specification, e.g., potentially determined based on a subcarrier spacing.

In another example, a maximum value of the application delay or a minimum value of the application delay or the value of the application delay can be determined based on UE capability.

In yet another example, a maximum value of the application delay or a minimum value of the application delay or the value of the application delay can be provided by the higher layer parameter. For one further consideration, if the higher layer parameter is not provided, the UE can assume a default value determined by the specification, e.g., potentially determined based on a subcarrier spacing.

In one example, within the maximum value of the application delay or the minimum value of the application delay or the value of the application delay, the UE is not expected to receive and/or transmit signal and/or channel using the MR (e.g., PDCCH reception using the MR). For one sub-example, the signal and/or channel can be SS/PBCH block. For another sub-example, the signal and/or channel can be PDCCH. For instance, the PDCCH can be with a particular type, e.g., Type0-PDCCH, Type0A-PDCCH, Type1-PDCCH, or Type2-PDCCH. For another instance, the PDCCH can be any PDCCH monitored in CSS. For yet another instance, the PDCCH can be any PDCCH monitored in USS. For yet another instance, the PDCCH can be any PDCCH. For yet another sub-example, the signal and/or channel can be PDSCH. For instance, the PDSCH can be scheduled by a particular type of PDCCH, e.g., Type0-PDCCH, Type0A-PDCCH, Type1-PDCCH, or Type2-PDCCH. For another instance, the PDSCH can be scheduled by any PDCCH monitored in CSS. For yet another instance, the PDSCH can be scheduled by any PDCCH monitored in USS. For yet another instance, the PDSCH can be scheduled by any PDCCH. For yet another sub-example, the signal and/or channel can be DL RS. For instance, the DL RS can be TRS. For another instance, the DL RS can be CSI-RS. For yet another sub-example, the signal and/or channel can be PUCCH. For yet another sub-example, the signal and/or channel can be PUSCH. For yet another sub-example, the signal and/or channel can be PRACH. For yet another sub-example, the signal and/or channel can be UL RS.

In another example, after the maximum value of the application delay or the minimum value of the application delay or the value of the application delay (e.g., and before the next triggering of the LR or before activation of the low power signal(s) or before the associated timer), the UE is expected to receive and/or transmit signal and/or channel using the MR (e.g., PDCCH reception using the MR).
For one sub-example, the signal and/or channel can be SS/PBCH block.
For another sub-example, the signal and/or channel can be PDCCH. For instance, the PDCCH can be with a particular type, e.g., Type0-PDCCH, Type0A-PDCCH, Type1-PDCCH, or Type2-PDCCH. For another instance, the PDCCH can be any PDCCH monitored in CSS. For yet another instance, the PDCCH can be any PDCCH monitored in USS. For yet another instance, the PDCCH can be any PDCCH.
For yet another sub-example, the signal and/or channel can be PDSCH. For instance, the PDSCH can be scheduled by a particular type of PDCCH, e.g., Type0-PDCCH, Type0A-PDCCH, Type1-PDCCH, or Type2-PDCCH. For another instance, the PDSCH can be scheduled by any PDCCH monitored in CSS. For yet another instance, the PDSCH can be scheduled by any PDCCH monitored in USS. For yet another instance, the PDSCH can be scheduled by any PDCCH.
For yet another sub-example, the signal and/or channel can be DL RS. For instance, the DL RS can be TRS. For another instance, the DL RS can be CSI-RS.
For yet another sub-example, the signal and/or channel can be PUCCH.
For yet another sub-example, the signal and/or channel can be PUSCH.
For yet another sub-example, the signal and/or channel can be PRACH.
For yet another sub-example, the signal and/or channel can be UL RS.

In one embodiment, there can be an application delay for the LR to transit from using a LR to using a MR, or to trigger the LR to operate in a state with low power (e.g., not to receive the signal/channel with low power such as LP-WUS and/or LP-SS). With reference to FIG. 7, the application delay for the LR is denoted as D2_LR.

In one example, the application delay for LR can be 0.

In another example, the application delay for the MR (e.g., D2_MR) can be same as the application delay for the LR (e.g., D2_LR).

In yet another example, the ending instance for the application delay for the MR can be aligned with the ending instance for the application delay for the LR.

In yet another example, the ending instance for the application delay for the MR can be no earlier than (or later than) the ending instance for the application delay for the LR.

In yet another example, the ending instance for the application delay for the MR can be no later than (or earlier than) the ending instance for the application delay for the LR.

In one example, the application delay is determined using a reference timing as the reception of the explicit trigger (e.g., the starting or ending instance of the explicit signal or channel).

In another example, the application delay is determined using a reference timing as the implicit trigger.

In yet another example, the application delay is determined using a reference timing as the transmission of the confirmation of the successful reception of the trigger (e.g., explicit signal or channel).

In one example, the application delay can be used for the UE to prepare for the LR to be with low power state (e.g., stopping to receive low power signal(s) such as LP-WUS and/or LP-SS), e.g., preparation time.

In another example, the application delay can be used for the UE to process signal and/or channel in order to be with low power state (e.g., stopping to receive low power signal(s) such as LP-WUS and/or LP-SS), e.g., processing time.

In one example, a maximum value of the application delay or a minimum value of the application delay or the value of the application delay can be determined by the specification, e.g., potentially determined based on a subcarrier spacing.

In another example, a maximum value of the application delay or a minimum value of the application delay or the value of the application delay can be determined based on UE capability.

In yet another example, a maximum value of the application delay or a minimum value of the application delay or the value of the application delay can be provided by the higher layer parameter. For one further consideration, if the higher layer parameter is not provided, the maximum value of the application delay or the minimum value of the application delay or the value of the application delay can be determined by the specification, e.g., potentially determined based on a subcarrier spacing.

In one example, after the maximum value of the application delay or the minimum value of the application delay or the value of the application delay (e.g., and before the next triggering of the LR or before activation of the low power signal(s) or before the associated timer), the UE is not expected to receive and/or transmit signal and/or channel using the LR
For one sub-example, the signal and/or channel can be low power wake-up-signal (LP-WUS) or part of the LP-WUS.
For another sub-example, the signal and/or channel can be synchronization signal received by the LR, e.g., to enable synchronization between the gNB 102 and the LR.

In another example, within the maximum value of the application delay or the minimum value of the application delay or the value of the application delay, the UE 116 is expected to receive and/or transmit signal and/or channel using the LR.
For one sub-example, the signal and/or channel can be low power wake-up-signal (LP-WUS) or part of the LP-WUS.
For another sub-example, the signal and/or channel can be synchronization signal received by the LR, e.g., to enable synchronization between the gNB 102 and the LR.

In one embodiment, the measurement procedure, including at least one of RRM, RLM, BM, BFR, can be determined based on the application delay(s).

In one example, the measurement procedure is applicable for RRC_IDLE and/or RRC_INACTIVE state.

In another example, the measurement procedure is applicable for RRC_CONNECTED state.

In one example, within the maximum value of the application delay or the minimum value of the application delay or the value of the application delay for the MR, the UE is not expected to perform measurement based on signal other than the low power signal(s), e.g., using the MR.
For one sub-example, the measurement can be based on SS/PBCH block.
For another sub-example, the measurement can be based on CSI-RS.

In another example, after the maximum value of the application delay or the minimum value of the application delay or the value of the application delay for the MR (e.g., and before the next triggering of the LR or before activation of the low power signal(s) or before the associated timer), the UE is expected to perform measurement based on signal other than the low power signal(s), e.g., using the MR.
For one sub-example, the measurement can be based on SS/PBCH block.
For another sub-example, the measurement can be based on CSI-RS.

In yet another example, within the maximum value of the application delay or the minimum value of the application delay or the value of the application delay for the LR, the UE is expected to perform measurement based on the low power signal(s), e.g., using the LR.
For one sub-example, the measurement can be based on LP-WUS or part of the LP-WUS.

For another sub-example, the measurement can be based on synchronization signal received by the LR (LP-SS), e.g., to enable synchronization between the gNB and the LR.

In yet another example, after the maximum value of the application delay or the minimum value of the application delay or the value of the application delay for the LR, the UE is not expected to perform measurement based on the low power signal(s), e.g., using the LR.
For one sub-example, the measurement can be based on LP-WUS or part of the LP-WUS.
For another sub-example, the measurement can be based on synchronization signal received by the LR (LP-SS), e.g., to enable synchronization between the gNB and the LR.

In one example, if a time duration is included in the application delay for the MR and not included in the application delay for the LR (e.g., when D2_LR <D2_MR), the UE does not expect to perform measurement based on RS located in the time duration. For instance, the measurement requirement can be relaxed based on the time duration.

In another example, if a time duration is included in the application delay for the LR and not included in the application delay for the MR (e.g., when D2_LR >D2_MR), the UE can perform measurement based on at least one RS from the MR or one RS from the LR.
For one sub-example, the measurement can be performed using either one of the RS from the MR (e.g., SS/PBCH block and/or CSI-RS) or the RS from the LR (e.g., LP-WUS or LP-SS), e.g., either instance from the measurement can be used for calculating the L1 RSRP or L3 RSRP.
For another sub-example, the measurement can be performed using both of the RS from the MR (e.g., SS/PBCH block and/or CSI-RS) and the RS from the LR (e.g., LP-WUS or LP-SS), e.g., both instances from the measurement can be used for calculating the L1 RSRP or L3 RSRP.

In one embodiment, an application delay can be extended based on UE's reception of a signal and/or channel.

For one example, the application delay for the MR and/or the application delay for the LR can be extended if the UE 116 receives a signal.
For one sub-example, the signal can be LP-WUS or part of the LP-WUS.
For another sub-example, the signal can be synchronization signal received by the LR (e.g., LP-SS), e.g., to enable synchronization between the gNB 102 and the LR.
For one sub-example, the application delay can be recounted/reset at the timing of receiving the signal.
For another sub-example, the duration of the extension can be provided by a higher layer parameter. For one further consideration, if the higher layer parameter is not provided, the duration of the extension can be determined as a default value in the specification, e.g., potentially determined based on a subcarrier spacing.

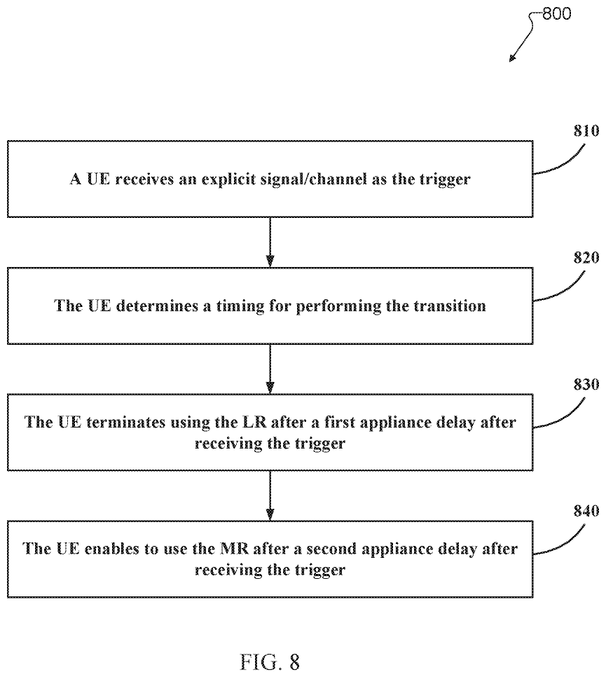

FIG. 8 illustrates a flowchart 800 of an example UE procedure for triggering the transition from using a LR to using a MR according to embodiments of the present disclosure. For example, flowchart 800 of an example UE procedure for triggering the transition from using a LR (e.g., such as LR 312) to use a MR (e.g., such as MR 314) can be performed by any of the UEs 111-116 of FIG. 1. This example is for illustration only and can be used without departing from the scope of the present disclosure.

The procedure begins in 810, a UE receives an explicit signal/channel as the trigger. In 820, the UE 116 determines a timing for performing the transition. In 830, the UE 116 terminates using the LR after a first application delay after receiving the trigger. In 840, the UE 116 enables to use the MR after a second application delay after receiving the trigger.

In one embodiment, an example UE procedure for triggering the transition from using a LR to using a MR, or triggering the use of the MR, or triggering the LR to operate in a state with low power is shown with reference to FIG. 8.

Any of the above variation embodiments can be utilized independently or in combination with at least one other variation embodiment. The above flowchart illustrates example methods that can be implemented in accordance with the principles of the present disclosure and various changes could be made to the methods illustrated in the flowchart herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver;
a low-power receiver (LR) configured to receive a low-power wake up signal (LP-WUS); and
a processor operably coupled to the transceiver and the LR, the processor configured to determine, based on the LP-WUS, an indication on whether to trigger the transceiver to receive a physical downlink control channel (PDCCH),
wherein the transceiver is further configured to receive the PDCCH based on the indication.

2. The UE of claim 1, wherein the PDCCH is associated with paging when the UE is in RRC_IDLE or RRC_INACTIVE state.

3. The UE of claim 1, wherein the PDCCH is monitored in an active period of a discontinuous reception (DRX) cycle when the UE is in RRC_CONNECTED state.

4. The UE of claim 1, wherein the processor is further configured to determine:
an application delay with respect to a reception of the LP-WUS, and
that the reception of the PDCCH is after the application delay.

5. The UE of claim 4, wherein:
the processor is further configured to determine a set of signals for radio resource management (RRM) before the application delay, and
the set of signals are not measured by the UE.

6. The UE of claim 1, wherein:
the processor is further configured to determine, based on the LP-WUS, an indication of an identity (ID), and
the transceiver is triggered to receive the PDCCH when an ID of the UE matches the ID in the indication.

7. The UE of claim 1, wherein the processor is further configured to trigger the transceiver to receive the PDCCH when the LR does not receive the LP-WUS for K consecutive times, where K is a positive integer that is provided by a higher layer parameter.

8. A method of a user equipment (UE) in a wireless communication system, the method comprising:
receiving a low-power wake up signal (LP-WUS) using a low-power receiver (LR);
determining, based on the LP-WUS, an indication on whether to trigger a transceiver of the UE to receive a physical downlink control channel (PDCCH); and
receiving, using the transceiver, the PDCCH based on the indication.

9. The method of claim 8, wherein the PDCCH is associated with paging when the UE is in RRC_IDLE or RRC_INACTIVE state.

10. The method of claim 8, wherein the PDCCH is monitored in an active period of a discontinuous reception (DRX) cycle when the UE is in RRC_CONNECTED state.

11. The method of claim 8, further comprising:
determining an application delay with respect to a reception of the LP-WUS, and
determining that the reception of the PDCCH is after the application delay.

12. The method of claim 11, further comprising:
determining a set of signals for radio resource management (RRM) before the application delay; and
determining not to measure the set of signals by the UE.

13. The method of claim 8, further comprising:
determining, based on the LP-WUS, an indication of an identity (ID), and
receiving the PDCCH when an ID of the UE matches the ID in the indication.

14. The method of claim 8, further comprising triggering the transceiver to receive the PDCCH when the LR does not receive the LP-WUS for K consecutive times, where K is a positive integer that is provided by a higher layer parameter.

15. A base station (BS) in a wireless communication system, the BS comprising:
a processor operably configured to:
determine an indication on whether a physical downlink control channel (PDCCH) is to be received by a user equipment (UE); and
determine to include the indication in a low-power wake up signal (LP-WUS); and
a transceiver operably coupled to the processor, the transceiver configured to:
transmit the LP-WUS; and
transmit the PDCCH when the indication in the LP-WUS indicates the PDCCH is to be received by the UE.

16. The BS of claim 15, wherein the PDCCH is associated with paging when the UE is in RRC_IDLE or RRC_INACTIVE state.

17. The BS of claim 15, wherein the PDCCH is to be received in an active period of a discontinuous reception (DRX) cycle when the UE is in RRC_CONNECTED state.

18. The BS of claim 15, wherein the processor is further configured to determine:
an application delay with respect to a transmission of the LP-WUS, and
that the transmission of the PDCCH is after the application delay.

19. The BS of claim 18, wherein:
the processor is further configured to determine a set of signals for radio resource management (RRM) before the application delay, and
the set of signals are not measured by the UE.

20. The BS of claim 15, wherein:
the processor is further configured to:
determine an indication of an identity (ID); and
determine to include the indication in the LP-WUS; and
the transceiver is configured to transmit the PDCCH when an ID of the UE matches the ID in the indication.
